(19) United States
(12) Patent Application Publication
(10) Pub. No.: US 2024/0345909 A1
(43) Pub. Date: Oct. 17, 2024

(54) DIAGNOSING AND AUTO-REMEDIATING REMOTE SITES OF A DISTRIBUTED CONTAINER ORCHESTRATION SYSTEM VIA AN EXTENSIBLE DIAGNOSIS CASE FRAMEWORK

(71) Applicant: VMWARE, Inc., Palo Alto, CA (US)

(72) Inventors: Qi Wang, Beijing (CN); Jian Lan, Beijing (CN); Yan QI, Beijing (CN); Liang CuI, Beijing (CN); Aravind Srinivasan, Sunnyvale, CA (US); Weiqing Wu, San Jose, CA (US); Uday Suresh Masurekar, Sunny, CA (US); Todd Sabin, Morganville, NJ (US); Hemanth Kumar Pannem, Danville, CA (US); Govind Haridas, San Jose, CA (US)

(21) Appl. No.: 18/133,877

(22) Filed: Apr. 12, 2023

(51) Int. Cl. G06F 11/07

(52) U.S. Cl. CPC G06F 11/079; G06F 11/0709

(57) ABSTRACT

The disclosure provides a method for diagnosing remote sites of a distributed container orchestration system. The method generally includes receiving a test suite custom resource defining an image to be used for a diagnosis of components of a workload cluster deployed at the remote sites, wherein the image comprises a diagnosis module and/or a user-provided plugin to be used for the diagnosis; identifying a failed component in the workload cluster; obtaining infrastructure information about the workload cluster; identifying the components of the workload cluster for diagnosis based on the failed component, the infrastructure information, and the test suite custom resource; identifying at least one diagnosis site of the remote sites where the components are running using the infrastructure information; and deploying a first pod at the at least one diagnosis site to execute the diagnosis of the one or more components.

Modern applications are applications designed to take advantage of the benefits of modern computing platforms and infrastructure. For example, modern applications can be deployed in a multi-cloud or hybrid cloud fashion. A multi-cloud application may be deployed across multiple clouds, which may be multiple public clouds provided by different cloud providers or the same cloud provider or a mix of public and private clouds. The term, “private cloud” refers to one or more on-premises data centers that might have pooled resources allocated in a cloud-like manner. Hybrid cloud refers specifically a combination of public cloud and private clouds. Thus, an application deployed across a hybrid cloud environment consumes both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that depend on a shared operating system (OS) kernel. Containerized applications, can include a collection of one or more related applications packaged into one or more containers. In some orchestration systems, a set of one or more related containers sharing storage and network resources, referred to as a pod, may be deployed as a unit of computing software. Container orchestration systems automate the lifecycle of containers, including such operations as provisioning, deployment, monitoring, scaling (up and down), networking, and load balancing.

Kubernetes® (K8S®) software is an example open-source container orchestration system that automates the deployment and operation of such containerized applications. In particular, Kubernetes may be used to create a cluster of interconnected nodes, including (1) one or more worker nodes that run the containerized applications (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

In some cases, the container orchestration system, running containerized applications, is distributed across a cellular network. A cellular network provides wireless connectivity to moving devices and generally comprises two primary subsystems: a mobile core connected to the Internet and a radio access network (RAN) composed of cell sites. In a RAN deployment, such as a fifth-generation network technology (5G) RAN deployment, cell site network functions can be realized as pods in container-based infrastructure. In particular, each cell site is deployed with an antenna and one or more hosts. The cell site hosts may be used to execute various network functions using containers (referred to herein as “cloud-native network functions (CNFs)). The CNFs may be deployed as pods of containers running within VMs of the cell site hosts or directly on an operating system (OS) of the cell site hosts.

5G is expected to deliver a latency of under 5 milliseconds and provide transmission speeds up to about 20 gigabytes per second. With these advancements, 5G is expected to support higher speed and more reliable mobile communications and video streaming services, immersive user interfaces, mission-critical applications (e.g., public safety, autonomous vehicles), smart home appliances, industrial robots, and the Internet-of-Things (IoT). To meet the 5G requirements, with respect to high network throughput and low latency, components of the cell sites and mobile core include specialized hardware, software, and customizations. For example, hosts at a 5G cell site may include various customizations to basic input output system (BIOS), firmware, drivers, hypervisors, VMs, guest OSs, and/or the like. In certain embodiments, a telecommunication cloud platform (TCP) enables configuring hosts of the cell sites and the mobile core of the 5G cellular network as such. The TCP uses a centralized management server configured to manage and customize components of the 5G cellular network.

Incorrect configuration of one or more components of the cell sites and mobile core may cause the network functions to fail, exhibit unintended latency, or otherwise perform inefficiently or incorrectly. A further complication is the large scale of a typical RAN. For example, a 5G RAN deployment may include more than 10,000 remote cell sites managed by the TCP. As such, diagnosis of a large number of servers may be required to ensure correct configuration of components in the cellular network.

### SUMMARY

One or more embodiments provide a method for diagnosing remote sites of a distributed container orchestration system. The method generally includes receiving, at a management cluster, a test suite custom resource defining an image to be used for a diagnosis of one or more components of a workload cluster deployed at the remote sites. The image comprises at least one of: a diagnosis module, or a user-provided plugin to be used for the diagnosis. The method generally includes identifying, at the management cluster, a failed component in the workload cluster. The method generally includes obtaining, by the management cluster, infrastructure information about the workload cluster. The infrastructure information identifies relationships between each of the one or more components of the workload cluster. The method generally includes identifying, by the management cluster, the one or more components of the workload cluster for diagnosis based on the failed component, the infrastructure information about the workload cluster, and the test suite custom resource. The method generally includes identifying, by the management cluster, at least one diagnosis site of the remote sites where the one or more components are running using the infrastructure information about the workload cluster. Further, the method generally includes deploying a first pod at the at least one diagnosis site to execute the diagnosis of the one or more components.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates an example cellular network, having at least a software-defined data center (SDDC), a mobile core, and multiple cell sites, in which embodiments of the present disclosure may be implemented.

FIG. 2A illustrates example physical and virtual components of the SDDC and the multiple cell sites illustrated in the cellular network of FIG. 1, according to an example embodiment of the present disclosure.

FIG. 2B illustrates an example cluster for running containerized workloads in the network environment of FIG. 2A, according to an example embodiment of the present disclosure.

FIG. 3A illustrates an example test suite custom resource (CR), according to an example embodiment of the present disclosure.

FIG. 3B illustrates an example configuration file specifying target components in a distributed container orchestration system for which diagnoses are to be performed, according to an example embodiment of the present disclosure.

FIGS. 4A and 4B provide an example workflow for diagnosing and/or auto-remediating components deployed at remote cell sites in a distributed container orchestration system, according to an example embodiment of the present disclosure.

FIG. 5 illustrates an example distributed container orchestration system configured for diagnosing and/or auto-remediating components deployed at remote cell sites, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for diagnosing remote sites of a distributed container orchestration system are described herein. The distributed container orchestration system may be a container orchestration system distributed across a cellular network. For example, worker nodes having containers running thereon and used to execute CNFs may be distributed across various cell sites in the cellular network. Such diagnosis may be performed to verify customizations of cell site components of the cellular network to confirm an ability of the components to support radio access network (RAN) (e.g., 5G RAN) telecommunication requirements.

A user may interact with a control plane of the container orchestration system to provide information about a workload cluster (e.g., having one or more worker nodes used to execute various CNFs), as well as diagnoses, intended by the user, to be performed for components associated with a failed component (e.g., a failed CNF pod) of the workload cluster. In certain embodiments, the user further identifies and provides information about the failed component in an additional configuration file. In certain other embodiments, the distributed container orchestration system detects the failed component. The diagnoses requested by the user may include the verification of customizations for the identified workload cluster and/or the verification of customizations of node(s), pod(s), host(s), and/or virtual machine(s) (VMs) (e.g., “components”) associated with the failed component, and which make up the workload cluster. As used herein, customizations of a node are customizations applied to a VM or a host deployed in a container orchestration system for running CNFs or control plane components. According to embodiments described herein, the user may request such diagnoses without knowledge of the underlying infrastructure of the workload cluster (e.g., without knowledge of the relationships between the different workers nodes, pods, hosts, VMs, etc. of the workload cluster).

For example, when a CNF pod fails, instead of requiring a user to identify a worker node associated with this failed pod in the workload cluster and provide such information as input to the control plane for diagnosis, the user may simply specify the CNF pod which has failed (e.g., specified as a target component in a configuration file) and specify a level of diagnosis that is to be performed for this failed CNF pod (e.g., specify that a node level verification is to be performed to verify operation systems layer customizations on the node where this CNF pod is located).

As such, the infrastructure information may be obtained by the control plane. For example, the control plane may obtain the infrastructure information for the specified workload cluster from a virtualization management platform deployed to carry out administrative tasks for at least the cluster, including managing components of the cluster. In particular, the virtualization management platform may maintain an inventory of at least the different components which make up the workload cluster, and their relationships. This infrastructure information may be used in conjunction with the user provided input such that diagnoses are performed at each layer, associated with the failed component, and specified by the user. As such, the distributed container orchestration system described herein allows a user to request diagnosis of remote site components in the system without knowledge of the underlying system infrastructure, thereby providing a more efficient and better user experience for the user.

In certain embodiments, a user may provide information about a workload cluster and diagnoses, intended by the user, to be performed for the workload cluster or components in the workload cluster, without providing information about a failed component, and without the system detecting any failed component. As such, the distributed container orchestration system may collect infrastructure information for the workload cluster and perform diagnoses on components in the cluster based on the diagnoses specified by the user. For example, where a user specifies that the system is to verify customizations at the VM level, customizations of multiple VMs running in the specified cluster may be verified (not just VMs associated with a failed component).

In certain embodiments, workload cluster information, as well as diagnoses requested by the user for the workload cluster, are provided, by the user, as one or more configuration files. Information included in the configuration files is packaged in an image for easy deployment and execution. The image, in conjunction with the obtained infrastructure information, includes all information necessary to execute the diagnoses at one or more remote cell sites.

Further, embedded scripts included in the image provide an easy and extensible way for users to add their own diagnosis cases, and in some cases, provide automatic remediation processes to rectify incorrect configuration(s) of one or more components of the remote cell sites.

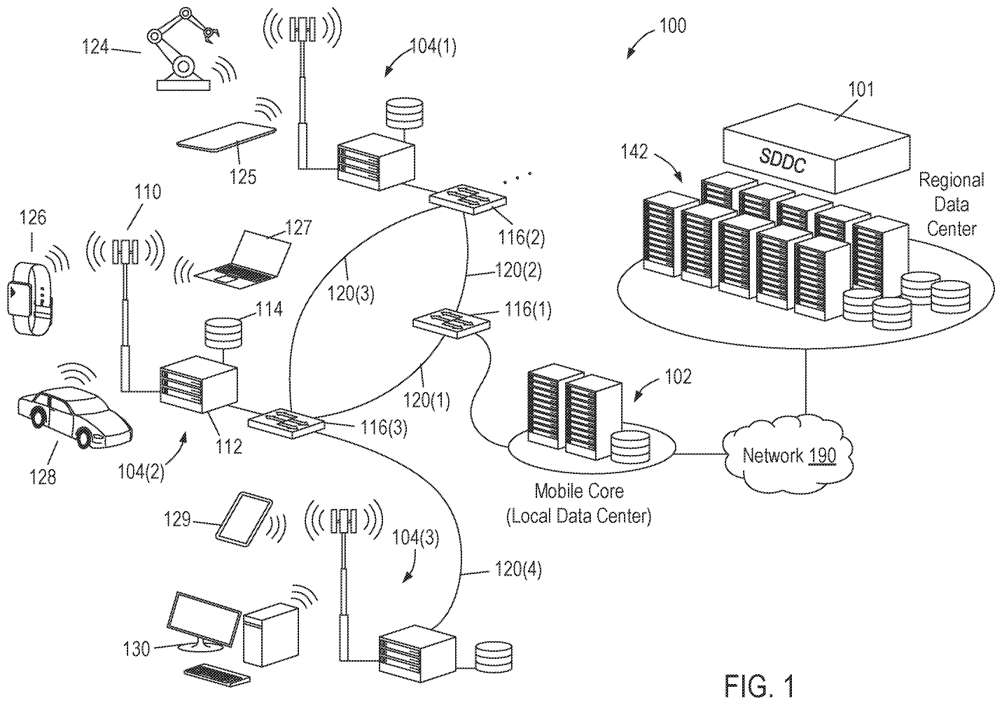

FIG. 1 illustrates an example cellular network 100 in which embodiments of the present disclosure may be implemented. Cellular network 100 provides wireless 5G connectivity to user equipment(s) (UE(s)). UEs include mobile phones, computers, automobiles, drones, industrial and agricultural machines, robots, home appliances, and Internet-of-Things (IoT) devices. Example UEs illustrated in FIG. 1 include a robot 124, a tablet 125, a watch 126, a laptop 127, an automobile 128, a mobile phone 129, and a computer 130. To provide such 5G connectivity, cellular network 100 includes a mobile core 102, a RAN composed of cell sites, such as example cell sites 104(1)-104(3) (individually referred to herein as “cell site 104” and collectively referred to herein as “cell sites 104”), and a telecommunication cloud platform (TCP) deployed in a software-defined data center (SDDC) at a regional data center (RDC).

Mobile core 102 is the center of cellular network 100. Cellular network 100 includes a backhaul network that comprises intermediate links, such as cables, optical fibers, and switches, and connects mobile core 102 to cell sites 104. In the example of FIG. 1, the backhaul network includes switches 116(1)-116(3) and intermediate links 120(1)-102(4). In certain embodiments, the intermediate links 120 are optical fibers. In certain embodiments, the backhaul network is implemented with wireless communications between mobile core 102 and cells sites 104.

Mobile core 102 is implemented in a local data center (LDC) that provides a bundle of services. For example, mobile core 102 provides (1) internet connectivity data and voice services, (2) ensures the connectivity satisfies quality-of-service (QoS) requirements of communication service providers (CSPs), (3) tracks UE mobility to ensure uninterrupted service as users travel, and (4) tracks subscriber usage for billing and charging. Mobile core 102 provides a bridge between the RAN in a geographic area and a larger IP-based Internet.

The RAN can span dozens, or even hundreds, of cell sites 104. Each cell site 104 includes an antenna 110 (e.g., located on a tower), one or more computer systems 112, and a data storage appliance 114. Cells sites 104 are located at the edge of cellular network 100. Computer systems 112 at each cell site 104 run management services that maintain the radio spectrum used by the UEs and make sure the cell site 104 is used efficiently and meets QoS requirements of the UEs that communicate with the cell site. Computer systems 112 are examples of host computer systems or simply “hosts.” A host is a geographically co-located server that communicates with other hosts in cellular network 100.

SDDC 101 is in communication with cell sites 104 and mobile core 102 through a network 190. Network 190 may be a layer 3 (L3) physical network. Network 190 may be a public network, a wide area network (WAN) such as the Internet, a direct link, a local area network (LAN), another type of network, or a combination of these.

SDDC 101 runs a telecommunications cloud platform (TCP) and a virtualization management platform (both not illustrated in FIG. 1) for managing the virtual environments of cell sites 104, and the LDC used to execute mobile core 102. The TCP uses a centralized management server to manage and customize hosts of cell sites 104 to meet cell site 5G requirements, and more specifically, high network throughout and low latency requirements. Additional details regarding such customizations are described in detail below.

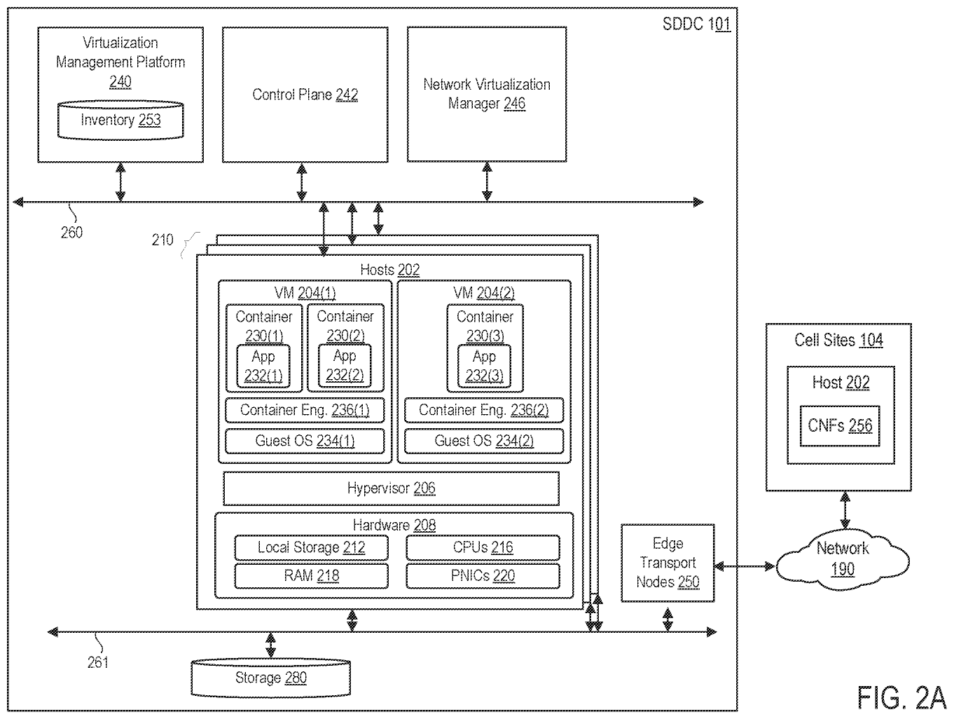

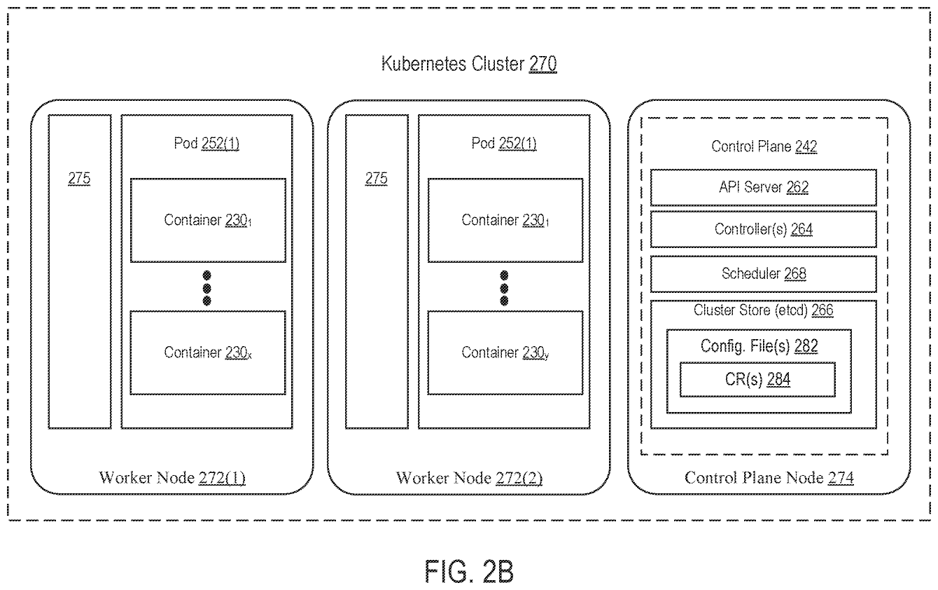

FIG. 2A illustrates example physical and virtual components of SDDC 101 and cell sites 104 illustrated in cellular network 100 of FIG. 1.

SDDC 101 includes one or more hosts 202, a management network 260, a data network 261, a virtualization management platform 240, a control plane 242, a network virtualization manager 246, edge transport nodes 250, and storage 280.

Host(s) 202 may be communicatively connected to management network 260 and data network 261. Data network 261 and management network 260 enables communication between hosts 202, and/or between other components and hosts 202.

Data network 261 and management network 260 may be separate physical networks or may be logically isolated using a single physical network and separate virtual local area networks (VLANs) or logical overlay networks, or a combination thereof. As used herein, the term “underlay” may be synonymous with “physical” and refers to physical components of SDDC 101. As used herein, the term “overlay” may be used synonymously with “logical” and refers to the logical network implemented at least partially within SDDC 101.

Host(s) 202 may be geographically co-located servers on the same rack or on different racks in any arbitrary location in SDDC 101. Host(s) 202 may be in a single host cluster 210 or logically divided into a plurality of host clusters 210.

Host(s) 202 may be constructed on a server grade hardware platform 208, such as an x86 architecture platform. Hardware platform 208 of each host 202 includes components of a computing device such as one or more processors (central processing units (CPUs)) 216, memory (random access memory (RAM)) 218, one or more network interfaces (e.g., physical network interfaces (PNICs) 220), local storage 212, and other components (not shown). CPU 216 is configured to execute instructions that may be stored in memory 218, and optionally in storage 212. The network interface(s) enable hosts 202 to communicate with other devices via a physical network, such as management network 260 and data network 261.

In certain embodiments, host(s) 202 access storage 280 using PNICs 220. In another embodiment, each host 202 contains a host bus adapter (HBA) through which input/output operations (I/Os) are sent to storage 280 over a separate network (e.g., a fibre channel (FC) network). Storage 280 may be a storage area network (SAN), network attached storage (NAS), or the like, and include one or more storage arrays. Storage 280 may include magnetic disks, solid-state disks (SSDs), flash memory, and/or the like.

In certain embodiments, storage 280 is software-based “virtual storage area network” (VSAN) that aggregates the commodity local storage 212 housed in or directly attached to hosts 202 of a host cluster 210. The VSAN provides an aggregate object store to VMs 204 running on hosts 202. Local storage 212 housed in hosts 202 may include combinations of solid state drives (SSDs) or non-volatile memory express (NVMe) drives, magnetic disks (MDs) or spinning disks or slower/cheaper SSDs, or other types of storages.

Each host 202 may be configured to provide a virtualization layer, also referred to as a hypervisor 206, that abstracts processor, memory, storage, and networking resources of hardware platform 208 of each host 202 into multiple virtual machines (VMs) 204 that run concurrently on the same host 202, such as VM 204₁ and VM 204₂ running on host 202 in FIG. 2A. In certain embodiments, hypervisor 206 runs in conjunction with an operating system (not shown) in host 202. In some embodiments, hypervisor 206 can be installed as system level software directly on hardware platform 208 of host 202 (often referred to as “bare metal” installation) and be conceptually interposed between the physical hardware and the guest operating systems executing in the VMs 204. It is noted that the term “operating system,” as used herein, may refer to a hypervisor. One example of hypervisor 206 that may be configured and used in embodiments described herein is a VMware ESXi™ hypervisor provided as part of the VMware vSphere® solution made commercially available by VMware, Inc. of Palo Alto, CA.

Further, each of VMs 204 implements a virtual hardware platform that supports the installation of a guest OS 234 which is capable of executing one or more applications 232. Guest OS 234 may be a standard, commodity operating system. Examples of a guest OS 234 include Microsoft Windows, Linux, and/or the like. Applications 232 may be any software program, such as a word processing program

Network virtualization manager 246 is a physical or virtual server that orchestrates a software-defined network layer. A software-defined network layer includes logical network services executing on virtualized infrastructure (e.g., of hosts 202). The virtualized infrastructure that supports logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure.

In certain embodiments, network virtualization manager 246 includes one or more virtual servers deployed as VMs. In certain embodiments, network virtualization manager 246 installs agents in hypervisor 206 to add a host 202 as a managed entity, referred to as an edge transport node 250. An edge transport node 250 may be a gateway (e.g., implemented by a router) between the internal logical networking of hosts 202 and the external network. Edge transport nodes 250 may be physical hosts and/or VMs. SDDC 101 also includes physical network devices (e.g., physical routers/switches), which are not explicitly shown in FIG. 2A.

One example of a software-defined networking platform that can be configured and used in embodiments described herein as network virtualization manager 306 and the software-defined network layer is a VMware NSX® platform made commercially available by VMware, Inc. of Palo Alto, California

Virtualization management platform 240 is a computer program that executes in a host 202 in SDDC 101, or alternatively, virtualization management platform 240 runs in one of VMs 204. Virtualization management platform 240 is configured to carry out administrative tasks for SDDC 101, including managing hosts 202, managing (e.g., configuring, starting, stopping, suspending, etc.) VMs 204 running within each host 202, provisioning VMs 204, transferring VMs 204 from one host 202 to another host 202, and/or the like.

Virtualization management platform 240 installs agent(s) in hypervisor 206 to add host(s) 202 as managed entities. Virtualization management platform 240 can logically group hosts 202 into host cluster 210 to provide cluster-level functions to hosts 202, such as VM migration between hosts 202 (e.g., for load balancing), distributed power management, dynamic VM placement according to affinity and anti-affinity rules, high availability, and/or the like. Virtualization management platform 240 can manage more than one host cluster 210. While only one virtualization management platform 240 is shown, SDDC 101 can include multiple virtualization management platforms 240 each managing one or more host clusters 210.

In certain embodiments, to carry out administrative tasks for SDDC 101, including managing host clusters 210, hosts 202, and VMs 204 and providing cluster-level functions, to name a few, virtualization management platform 240 may maintain a virtualization management platform inventory 253 (also referred to herein as “inventory 253”) of inventory objects. The inventory objects may be either containers of other inventory objects, such as folders, or inventory objects that represent components managed by virtualization management platform 240, including SDDC 101, host clusters 210, hosts 202, VMs 204, templates, networks, and/or resource pools. In other words, the inventory is a hierarchical list of inventory objects representing virtual and physical objects managed by virtualization management platform 240. The inventory objects are organized in a hierarchy to illustrate relationships between virtual and physical objects managed by virtualization management platform 240 and provide a structure over which virtualization management platform 240 may manage the virtual and physical components in SDDC 101. In the inventory hierarchy, an inventory object representing SDDC 101 may have multiple branches to inventory objects representing host clusters in SDDC 101. Each inventory object representing a host cluster may have multiple branches to inventory objects representing hosts running on the respective host cluster. Each inventory object representing a host may have multiple branches to inventory objects representing VMs running on the respective host. Thus, the inventory may maintain SDDC-host cluster relationships for SDDC 101, host-cluster relationships for each host cluster 210, and VM-host relationships for each host 202 in each host cluster 210 identified in inventory 253.

In certain embodiments, SDDC 101 includes a container orchestrator. The container orchestrator implements a container orchestration control plane (also referred to herein as the “control plane 242”), such as a Kubernetes control plane, to deploy and manage applications and/or services thereof on hosts 202 using containers 230. In particular, each VM 204 includes a container engine 236 installed therein and running as a guest application under control of guest OS 234. Container engine 236 is a process that enables the deployment and management of virtual instances, referred to herein as “containers,” in conjunction with OS-level virtualization on guest OS 234 within VM 204 and the container orchestrator. Containers 230 provide isolation for user-space processes executing within them. Containers 230 encapsulate an application (and its associated applications 232) as a single executable package of software that bundles application code together with all of the related configuration files, libraries, and dependencies required for it to run.

Control plane 242 runs on a cluster of hosts 202 and may deploy containerized applications as containers 230 on the cluster of hosts 202. Control plane 242 manages the computation, storage, and memory resources to run containers 230 in the host cluster. Further, control plane 242 may support the deployment and management of applications (or services) in the container-based cluster using containers 230. In certain embodiments, hypervisor 206 is integrated with control plane 242 to provide a “supervisor cluster” (i.e., management cluster) that uses VMs to implement both control plane nodes and compute objects managed by the Kubernetes control plane.

In certain embodiments, control plane 242 deploys applications as pods of containers 230 running on hosts 202, either within VMs 204 or directly on an OS of hosts 202, in SDDC 101. A pod is a group of one or more containers 230 and a specification for how to run the containers 230. A pod may be the smallest deployable unit of computing that can be created and managed by control plane 242.

In certain embodiments, control plane 242 is further configured to deploy and manage pods executing (e.g., on hosts 202) in cell sites 104. In particular, cell sites 104 perform software functions using containers. In the RAN, the cell sites 104 may include CNFs 256 deployed as pods, running on one or more hosts 202, by the control plane. The CNFs 256 may be deployed as pods of containers running within VMs of hosts 202 or directly on an OS of hosts 202, of cell sites 104.

An example container-based cluster for running containerized applications 232 and CNFs 256 is illustrated in FIG. 2B. While the example container-based cluster shown in FIG. 2B is a Kubernetes cluster 270, in other examples, the container-based cluster may be another type of container-based cluster based on container technology, such as Docker Swarm clusters. As illustrated in FIG. 2B, Kubernetes cluster 270 is formed from a cluster of interconnected nodes, including (1) one or more worker nodes 272 that run one or more pods 252 having containers 230 and (2) one or more control plane nodes 274 having control plane components running thereon that control the cluster (e.g., where a node is a physical machine, such as a hosts 202, or a VM 204 configured to run on a host 202).

Each worker node 272 includes a kubelet 275. Kubelet 275 is an agent that helps to ensure that one or more pods 252 run on each worker node 272 according to a defined state for the pods 252, such as defined in a configuration file. Each pod 252 may include one or more containers 230. The worker nodes 272 can be used to execute various applications and software processes (e.g., CNFs) using containers 230. Further, each worker node 272 may include a kube proxy (not illustrated in FIG. 2B). A kube proxy is a network proxy used to maintain network rules. These network rules allow for network communication with pods 252 from network sessions inside and/or outside of Kubernetes cluster 270.

Control plane 242 (e.g., running on one or more control plane nodes 274) includes components such as an application programming interface (API) server 262, controller(s) 264, a cluster store (etcd) 266, and scheduler(s) 268. Control plane 242's components make global decisions about Kubernetes cluster 270 (e.g., scheduling), as well as detect and respond to cluster events.

API server 262 operates as a gateway to Kubernetes cluster 270. As such, a command line interface, web user interface, users, and/or services communicate with Kubernetes cluster 270 through API server 262. One example of a Kubernetes API server 262 is kube-apiserver. The kube-apiserver is designed to scale horizontally—that is, this component scales by deploying more instances. Several instances of kube-apiserver may be run, and traffic may be balanced between those instances.

Controller(s) 264 is responsible for running and managing controller processes in Kubernetes cluster 270. As described above, control plane 160 may have (e.g., four) control loops called controller processes, which watch the state of Kubernetes cluster 270 and try to modify the current state of Kubernetes cluster 270 to match an intended state of Kubernetes cluster 270.

Scheduler(s) 268 is configured to allocate new pods 252 to worker nodes 272.

Cluster store (etcd) 266 is a data store, such as a consistent and highly-available key value store, used as a backing store for Kubernetes cluster 270 data. In certain embodiments, cluster store (etcd) 266 stores configuration file(s) 282, such as JavaScript Object Notation (JSON) or YAML files, made up of one or more manifests that declare intended system infrastructure and workloads to be deployed in Kubernetes cluster 270. Kubernetes objects, or persistent entities, can be created, updated and deleted based on configuration file(s) 282 to represent the state of Kubernetes cluster 270.

A Kubernetes object is a “record of intent”—once an object is created, the Kubernetes system will constantly work to ensure that object is realized in the deployment. One type of Kubernetes object is a custom resource definition (CRD) object (also referred to herein as a “custom resource (CR) 284”) that extends API 262 or allows a user to introduce their own API into Kubernetes cluster 270. In particular, Kubernetes provides a standard extension mechanism, referred to as custom resource definitions, that enables extension of the set of resources and objects that can be managed in a Kubernetes cluster.

In certain embodiments, cluster store (etcd) 266 includes a test suite CR (e.g., defined via a configuration file 282). The test suite CR defines, in a declarative way, diagnoses to be performed on cell sites 104. In particular, as described above, to meet the 5G requirements, cell sites 104 include specialized hardware, software, and customizations. For example, 5G cell site customizations may include one or more of the various customizations provided in Table 1 below:

TABLE 1
Example Customizations

| Compo- | |
|---|---|
| nent/ | |
| Layer | Customization |
| Host | BIOS tuning, such as CPU power and performance, Thermal |
| | Design Power (TDP), and/or turbo boost |
| | Firmware updates for different NICs |
| | Drivers |
| | Forward error correction (FEC) accelerator |
| | Peripheral component interconnect (PCI) device single root I/O |
| | virtualization (SR-IOV) settings |
| | PCI device pass-through enablement |
| | Hypervisor tuning |
| VM | CPU pinning |
| | Memory optimization, such as sched.mem.prealloc |
| | Hyper-threading aware, such as numa.vcpu.preferHT |
| Node | RealTime kernel |
| | Custom packages, such as tuned and/or stalld |
| | Kernel arguments, such as huge page settings |
| | Data plane development kit (DPDK) kernel modules, such as |
| | vfio-pci |
| Cluster | Internet protocol (IP) address management (IPAM) whereabouts |
| | Multus for extra pod interfaces |
| | IPVLAN |
| | Media Access Control (MAC) VLAN |
| | CPU and memory reservation for a pod |

The above-provided customizations are not an exhaustive list, and many other customizations may be provided to one or more of these components, or other components not listed.

The test suite CR defines an image to be used for a diagnosis. The image includes an entry point script, diagnosis module(s), and diagnosis case(s) for customization layers of different cell sites 104. Diagnosis modules are software components used to verify customizations of different cell site 104 layers. The diagnosis modules may include a “clusterVerify” module configured to verify customizations at the cluster level, a “nodeVerify” module configured to verify customizations at the node level (e.g., customizations to a VM or host configured to run CNFs or control plane components in a container-based cluster), a “vmVerify” module configured to verify customizations at the VM level, and/or a “hostVerify” module configured to verify customizations at the host level.

Diagnoses, or diagnosis cases, performed by each of the diagnosis modules, respectively, may include one or more of the various diagnosis cases provided in Table 2 below:

TABLE 2
Example Diagnosis Cases

| Compo- | |
|---|---|
| nent/ | |
| Layer | Diagnosis Cases |
| Host | Diagnose BIOS tuning, such as CPU power and performance, |
| | TDP, and/or turbo boost |
| | Diagnose firmware updates for different NICs |
| | Diagnose PCI device SR-IOV settings |
| | Diagnose PCI device pass-through enablement |
| | Diagnose time configuration |
| VM | Diagnose CPU pinning |
| | Diagnose memory optimization, such as sched.mem.prealloc |
| | Diagnose huge page enablement |
| | Diagnose SR-IOV NIC |
| Node | Diagnose RealTime kernel |
| | Diagnose custom packages, such as tuned and/or stalld |
| | Diagnose kernel arguments, such as huge page settings |
| | Diagnose DPDK kernel modules, such as vfio-pci |
| | Diagnose maximum transmission unit (MTU) settings |
| Cluster | Diagnose cluster nodes information |
| | Diagnose important CR status |
| | Diagnose Kubernetes service (kube-apiserver, etcd, core-dns, |
| | etc.) status |
| | Diagnose TCA service (TCA-cluster-operator, nodeconfig- |
| | operator, vmconfig-operator) status |

The above-provided diagnosis cases are not an exhaustive list, and many other diagnosis cases may be performed by the diagnosis modules, or other modules not listed.

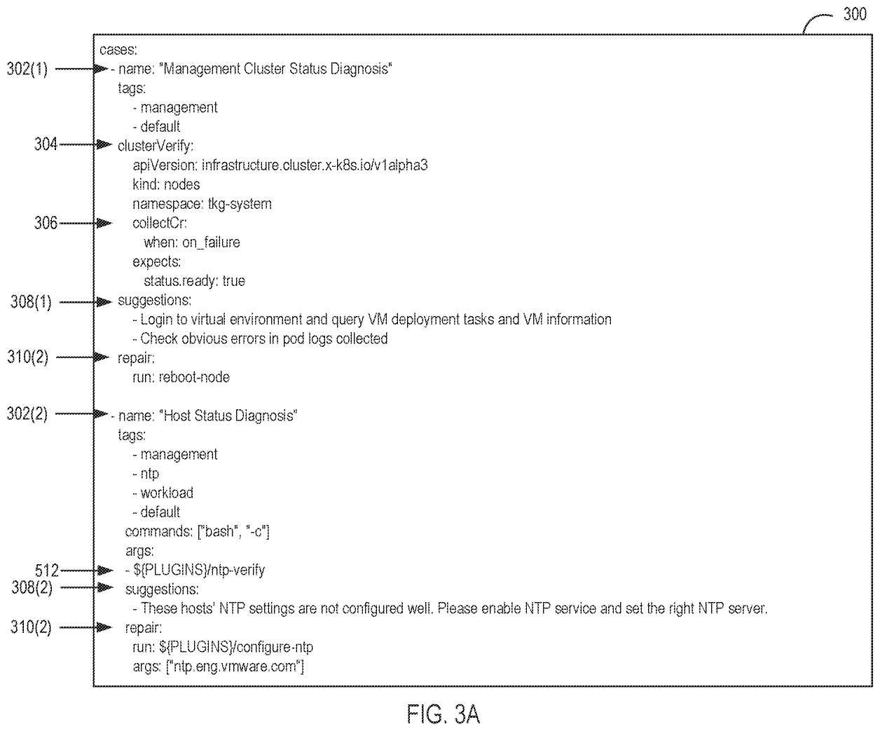

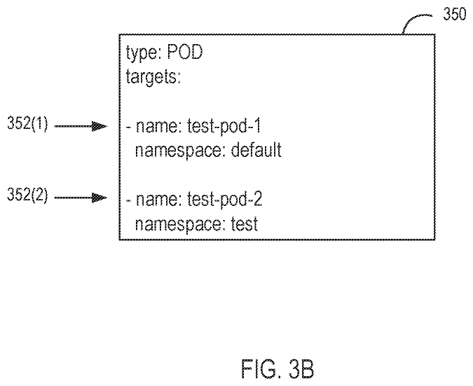

An example test suite CR 300 is provided in FIG. 3. As illustrated, test suite CR 300 declares two diagnosis cases 302 which are to be executed: diagnosis case 302(1) named “Management Cluster Status Diagnosis” and diagnosis case 302(2) named “Host Status Diagnosis.”

For the first diagnosis case 302(1), test suite CR 300 declares that, diagnosis module 304, clusterVerify, is to be used for the diagnosis. Diagnosis module 304, clusterVerify, supports Kubernetes cluster resources verification for a workload cluster. In other words, by specifying clusterVerify diagnosis module 304 in test suite CR 300, the system may perform diagnoses at the cluster level (e.g., diagnoses illustrated in Table 2, for example) for a specified cluster (e.g., associated with a failed component).

In certain embodiments, a user may define, in test suite CR 300, an apiVersion, kind, and namespace of particular cluster components which are to be verified using the clusterVerify diagnosis module 304. However, a user is not required to specify particular components (e.g., worker nodes, hosts, VMs, etc.) which are to be diagnosed. For example, as described below, in certain embodiments, components which are to be diagnosed are determined based on a failed component (e.g., indicated by a user or detected by the system) and infrastructure information gathered for a workload cluster specified in a kubeconfig file (e.g., provided by the user).

Further, test suite CR 300 may define, at 306, what an expected result is when execution of the diagnosis case fails (e.g., “when: on_failure”).

In certain embodiments, a user may provide suggestions 308 for each diagnosis case 302, recommending actions to be taken should the particular diagnosis case 302 fail. For example, suggestions 308(1) for first diagnosis case 302(1) in test suite CR 300 include suggestions to “Login to virtual environment and query VM deployment tasks and VM information” and “Check obvious errors in pod logs collected.”

Additionally, in certain embodiments, a user may specify automatic repair functions 310, in test suite CR 300 for each diagnosis case 302, which are to be executed should the particular diagnosis case 302 fail. For example, an automatic repair function 310(1) for first diagnosis case 302(1) includes auto-repair function “run: reboot-node,” which reboots the node so that it starts from a rebooted state.

In certain embodiments, the diagnosis cases and/or automatic repair functions declared by the user in a test suite CR include diagnosis cases and/or automatic repair functions implemented via one or more plugins provided in the system by the user. A plugin is a software add-on that, when installed, extends existing features and/or processes of a system (e.g., in this case, extends available diagnosis cases and/or auto-repair functions). A plugin may be written in any computer programming language, including, for example, Bash, Python, and/or Golang. An example user-provided plugin may be a script to execute a diagnosis case for a vendor-specific customization.

For example, in test suite CR 300, second diagnosis case 302(2), “Etcd Status Diagnosis,” may be a diagnosis case customized by the user that is executed via a user-provided plugin 312, “${PLUGINS}/ntp-verify.” Further, automatic repair functions 310(2) declared for second diagnosis case 302(2), when second diagnosis case 302(2) fails, include automatic repair functions executed via “${PLUGINS}/configure-ntp” (e.g., a user-provided plugin to customize repair functions that are performed by the system).

As such, when defining an image to be used for a diagnosis, a number and/or type of diagnosis cases and/or automatic-repair functions that are available and that can be declared in the test suite CR, may be limited based on an amount and/or type of plugins provided by a user.

Returning to FIG. 2B, in addition to the test suite CR, cluster store (etcd) 266 may also include a kubeconfig file used to define, for the image (e.g., defined via test suite CR), a workload cluster that is to be diagnosed. A kubeconfig file is a YAML file containing Kubernetes cluster details, certificate, and secret token information to authenticate the cluster. The kubeconfig file is used to configure access to Kubernetes, for example, when used in conjunction with a kubectl command line tool.

Further, in certain embodiments, cluster store (etcd) 266 also includes another configuration file that specifies one or more failed components in a distributed container orchestration system. For example, FIG. 3B illustrates an example configuration file 350, specifying failed components 352 in a distributed container orchestration system, that may be provided as user input to specify that diagnoses are to be performed for components associated with the failed components identified in example configuration file 350. Specifically example configuration file 350 specifies that diagnoses are to be performed for components associated with failed component 352(1), “test-pod-1,” and failed component 352(2), “test-pod-2.” In this example, “test-pod-1” and “test-pod-2” may be pods which previously failed; thus, a user may desire to perform such diagnoses to better understand why these pods may have failed. As described below, to perform diagnoses for these failed pods, infrastructure information for a workload cluster where these pods were previously running may be gathered from a virtualization management platform 240 and used to identify components (e.g., hosts, VMs, etc.) associated with these failed components, e.g., failed pods.

The test suite CR, the kubeconfig file identifying the workload cluster, and, in some cases, an additional configuration file specifying target component(s) and/or user-provided plugin(s) may be packaged into the image. The image includes executable code for performing the intended diagnosis cases at one or more cell sites 104 in the cellular network. For example, in certain embodiments, the image is deployed and run in existing containers 230, at the cell sites 104, to perform the diagnosis. Alternatively, in certain embodiments, the image is used to create pods 252 at the cell sites 104 for running the diagnosis.

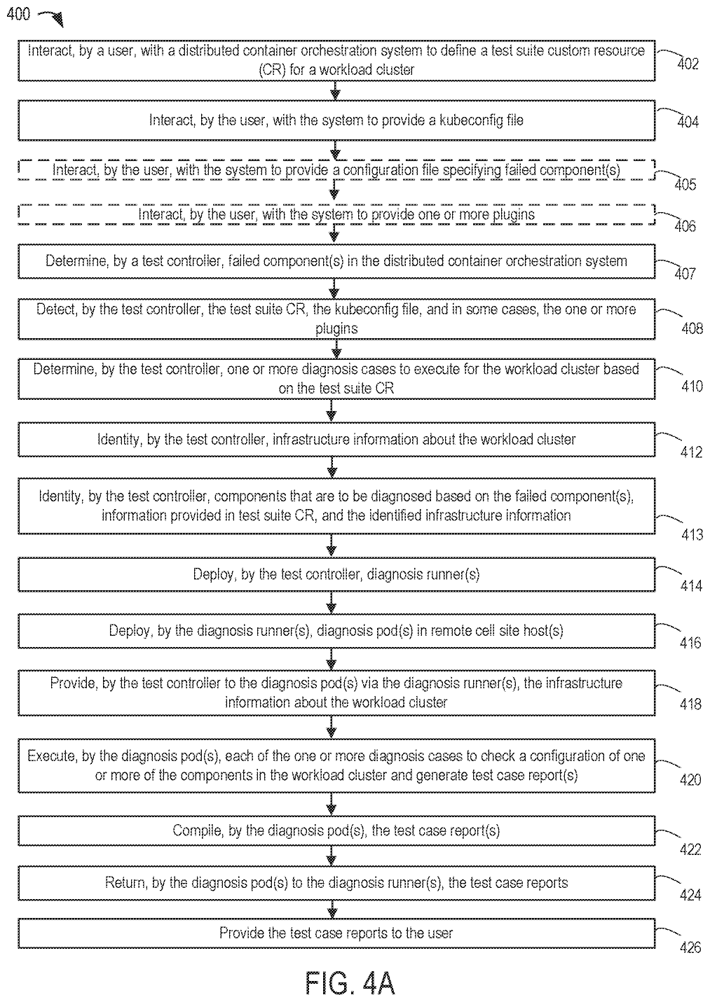

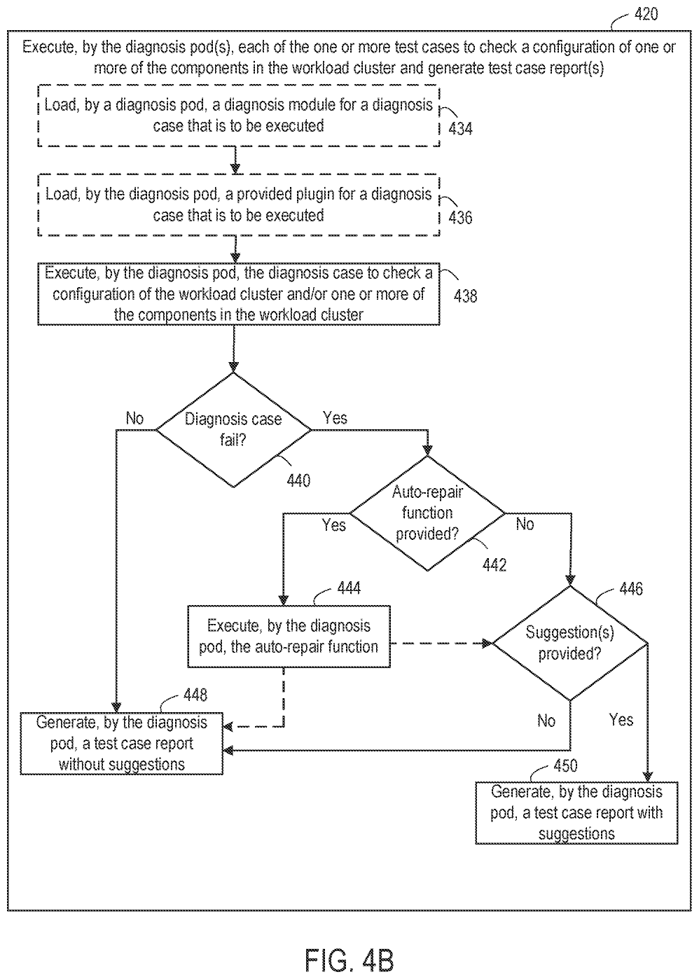

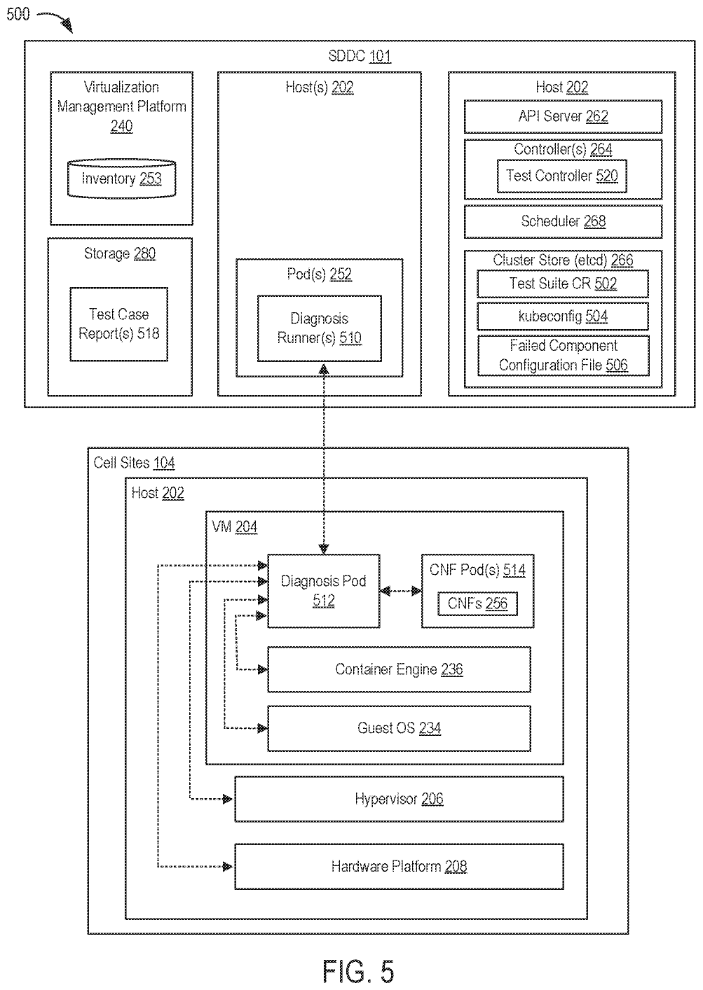

FIGS. 4A and 4B provide an example workflow 400 for diagnosing and/or auto-remediating components deployed at remote cell sites 104 in a distributed container orchestration system, according to an example embodiment of the present disclosure. More specifically, workflow 400 may be used to diagnose and/or auto-remediate components associated with failed CNF pods (e.g., identified as failed components in a user-provided configuration file or detected by the distributed container orchestrations system). Workflow 400 may be described with respect to the example distributed container orchestration system 500 of FIG. 5. In particular, FIG. 5 illustrates an example distributed container orchestration system 500 configured for diagnosing and/or auto-remediating components deployed at remote cell sites 104 that are associated with the failed CNF pods.

Workflow 400, begins at operation 402, with a user interacting with a distributed container orchestration system, and more specifically a control plane of the system, to define a test suite CR. For example, as shown in FIG. 5, the user interacts with API server 262 to define a test suite CR 502. Test suite CR 502 defines, in a declarative way, diagnosis cases to be performed on remote cell sites 104 to verify customizations of various cell site 104 components.

At operation 404, the user interacts with the control plane to provide a kubeconfig file and a configuration file specifying target component(s). For example, as shown in FIG. 5, the user interacts with API server 262 to provide kubeconfig file 504 and target component(s) configuration file 506. Kubeconfig file 504 defines a workload cluster with components that are intended to be diagnosed.

Optionally, at operation 405, the user interacts with the control plane to provide a configuration file specifying failed component(s). Failed components configuration file 506 identifies failed component(s) in distributed container orchestration system 500. Failed component configuration file 506 may be provided as user input to specify that diagnoses are to be performed for components associated with the failed component(s) identified in configuration file 506. The failed component(s) identified in target component(s) configuration file 506 may be components in distributed container orchestration system 500 that have failed. For example, failed component configuration file 506 may identify two CNF pods that have failed in distributed container orchestration system 500. An example failed component configuration file 506 is illustrated in FIG. 3B.

Optionally, at operation 406, the user interacts with the control plane to provide one or more plugins. The plugins are software add-ons used to extend diagnosis cases and/or automatic remediation processes that may be performed for the workload cluster. A plugin provided, at operation 406, may be a plugin referenced in the test suite CR (e.g., test suite CR 502).

At operation 407, a test controller determines one or more component in the distributed container orchestration system that have failed. For example, in FIG. 5, a controller 264, and more specifically, a test controller 520, (1) identifies one or more failed components based on failed component(s) identified in the failed component configuration file 506, where such a file is provided by a user at operation 405, or (2) detects one or more failed components in distributed container orchestration system 500.

At operation 408, the test controller detects the test suite CR, the kubeconfig file, and in some cases, the one or more plugins. For example, in FIG. 5, test controller 520, detects test suite CR 502 and kubeconfig 504 (and, in some cases, plugins deployed by the user).

In response to detecting the test suite CR, at operation 410, the test controller determines one or more diagnosis cases to execute for the workload cluster based on the test suite CR 502. As described above, the test suite CR defines an image to be used for a diagnosis, and the image includes at least one or more diagnosis cases for customization layers of different cell sites 104 which the user requests to be executed. The diagnosis cases may be diagnosis cases which use diagnosis modules, such as clusterVerify, nodeVerify, vmVerify, and/or hostVerify modules and/or diagnosis cases executed using the user-provided plugins.

In response to detecting the kubeconfig file, at operation 412, the test controller identifies infrastructure information about the workload cluster specified in the kubeconfig file. For example, in FIG. 5, test controller 520 obtains infrastructure information about the workload cluster from virtualization management platform 240. The infrastructure information may be stored in inventory 253 maintained by virtualization management platform 240. The infrastructure information may include information about hosts, worker nodes (of different cell sites), VMs, and pods which make up the particular workload cluster, and their relationships (e.g., a first VM is running on a first host, that is a first worker node of the workload cluster).

At operation 413, the test controller determines which components are to be diagnosed based on the failed component(s) determined at operation 407 and information provided in test suite CR 502 and the identified infrastructure information. In particular, the test controller uses the identified infrastructure information to identify components associated with the failed component(s). Further, the test controller narrows down which of the components associated with the failed component(s) are to be diagnosed, based on diagnosis modules identified in test suite CR 502. In this example, test controller 520 identifies hosts, VMs, worker nodes, and a cluster where the failed CNF pods are running using the infrastructure information. Test controller 520 then determines which of these identified components are to be diagnosed based on diagnosis modules identified in test suite CR 502 (e.g., where a vmVerify diagnosis module is included in test suite CR 502, then only VMs among the identified components are to be diagnosed).

At operation 414, the test controller deploys one or more diagnosis runners. For example, in FIG. 5, test controller 520 deploys diagnosis runner(s) 510 as pod(s) 252 in the management cluster in SDDC 101. Test controller 520 deploys diagnosis runner(s) 510 based on the image specified in test suite CR 502. In particular, the image of each diagnosis runner 510 is the image packaged with diagnosis modules, diagnosis cases, and optional user plugins, where provided. Test controller 520 also provides information about which cell sites 104 (e.g. worker nodes) are to be diagnosed, based on the components identified for diagnosis, at operation 413. For example, where, at operation 413, test controller 520 determines VMs associated with the failed CNF pods are to be diagnosed, then test controller 520 may use the infrastructure information to identify worker nodes where these VMs are running and indicate these worker nodes to diagnosis runner(s) 510. Diagnosis runner(s) 510 are configured to deploy diagnosis pods 512 at the indicated worker nodes (e.g., for executing one or more diagnosis cases defined in the test suite CR) and collect test data returned from the diagnosis pods 512.

At operation 416, the diagnosis runner(s) deploy diagnosis pods in remote cell site worker node(s). For example, in FIG. 5, diagnosis runner(s) 510 deploys diagnosis pods 512 to hosts 202 (e.g., worker nodes) of cell sites 104 indicated by test controller 520. In certain embodiments, diagnosis pods 512 are lightweight and are deleted after the diagnosis process for one or more diagnosis cases is complete. Diagnosis pods 512 may require minimal resources of hosts 202 to mitigate performance impact on executing CNFs 256 in CNF pods 514.

At operation 418, the test controller provides the infrastructure information about the workload cluster to the diagnosis pod(s). For example, in FIG. 5, test controller 520 provides the infrastructure information, obtained from virtualization management platform 240, to diagnosis pods 512 via diagnosis runners 510.

At operation 420, the diagnosis pods execute each of the one or more diagnosis cases. In particular, each diagnosis pod 512 in FIG. 5 executes the one or more diagnosis cases (e.g., defined in test suite CR 502) to check a configuration of one or more of the components in the workload cluster and generate test case report(s) 518. Execution of the diagnosis cases may be performed using diagnosis modules provided in the image and/or plugins provided by the user.

FIG. 4B illustrates example operations performed at operation 420, by a diagnosis pod 512, to execute a diagnosis case defined in test suite CR 502.

As described above with respect to FIG. 3A, a diagnosis case may be executed using a diagnosis module (e.g., included in the image/defined in test suite CR 502) only, executed using a diagnosis module and user-provided plugin(s) (e.g., for performing automatic repair functions), or executed using only plugin(s), where the user-provided plugin(s) is used to carry out customized diagnoses and, in some cases, automatic repair functions. As such, based on the diagnosis case declared in test suite CR 502, diagnosis pod 512 may either load a diagnosis module (e.g., at operation 434), load a user-provided plugin (e.g., at operation 436), or load both a diagnosis module and a user-provided plugin (e.g., at operations 434 and 436).

At operation 438, diagnosis pod 512 executes the diagnosis case to check a configuration of the workload cluster and/or one or more of the components of the workload cluster. For example, where diagnosis pod 512 loads a nodeVerify module, at operation 538, diagnosis pod 512 may verify operation system (OS) layer customizations on nodes of the workload cluster where CNF pods 514 are located. For example, nodeVerify module may verify that custom packages such as tuned and/or Stalld are installed on each of the nodes, a version of a RealTime kernel installed on each of the nodes, MTU settings for each of the nodes (e.g., where MTU settings limit data packet size for each node), and/or the like.

At operation 440, diagnosis pod 512 determines whether the diagnosis case has failed. A diagnosis case fails where one or more configurations/customizations of the component, checked during execution of the diagnosis case, are incorrect. Where, at operation 440, diagnosis pod 512 determines that the diagnosis case did not fail (e.g., passed), at operation 448, diagnosis pod 512 generates a test case report 518 for the diagnosis case. The test case report 518 may include status information for the diagnosis check (e.g., a pass status), report/log information, and/or the like. On the other hand, where, at operation 440, diagnosis pod 512 determines that the diagnosis case did, in fact, fail, at operation 442, diagnosis pod 512 determines whether an automatic repair function is provided for the diagnosis case (e.g., such as automatic repair function 310(2) illustrated in FIG. 3A for first diagnosis case 302(1)).

Where, at operation 440, diagnosis pod 512 determines that at least one automatic repair function is provided for the diagnosis case, at operation 444, diagnosis pod 512 executes the automatic repair function. In certain embodiments, a user-provided plugin is used to execute the automatic repair function. In certain embodiments, after executing the automatic repair function, at operation 448, diagnosis pod 512 generates a test case report 518 for the diagnosis case (e.g. without suggestions). Alternatively, in certain embodiments, after executing the automatic repair function, at operation 446, diagnosis pod 512 determines whether suggestion(s) are provided for the diagnosis case (e.g., such as suggestions 308(1) illustrated in FIG. 3A for first diagnosis case 302(1)). In particular, in some cases both automatic repair function(s) and suggestion(s) are defined for a diagnosis case (e.g., in test suite CR 502).

Where, at operation 446, diagnosis pod 512 determines that no suggestion(s) are defined for the diagnosis case, at operation 448, diagnosis pod 512 generates a test case report 518 for the diagnosis case (e.g., without suggestions). Alternatively, where, at operation 446, diagnosis pod 512 determines that suggestion(s) are defined for the diagnosis case, at operation 450, diagnosis pod 512 generates a test case report 518 for the diagnosis case with such suggestions.

Returning to operation 442, in cases where diagnosis pod 512 determines that an automatic repair function is not provided for the diagnosis case, at operation 446, whether suggestion(s) are provided for the diagnosis case. Based on whether suggestions are provided for the diagnosis case or not, a test case report generated by diagnosis pod 512 for the diagnosis case may or may not include suggestions.

Returning to FIG. 4A, at operations 422 and 424, the diagnosis pods 512 compile the test case report(s) 518 and return the test case report(s) to the diagnosis runner(s) 510. At operation 426, the test case report(s) 518 are provided to the user. In some cases, the diagnosis runner(s) 510 provide the test case report(s) to test controller 520, and test controller 520 stores these report(s) in persistent volumes in storage 280, where they may be accessed by the user.

Although FIGS. 4A and 4B describe a test controller (e.g., test controller 520 in FIG. 5) obtaining infrastructure information about a workload cluster from a virtualization management platform (e.g., virtualization management platform 240 in FIG. 5) and providing this information to diagnosis pod(s) (e.g., diagnosis pods 512 in FIG. 5) for diagnosis, in certain embodiments, the diagnosis pods are also configured to obtain this information directly from a virtualization management platform. For example, workload cluster information, as well as diagnoses requested by the user, packaged in an image may be deployed by a user for diagnosis of components at a cell site. Diagnosis pod(s) deployed at the cell site may obtain the infrastructure information for performing the diagnosis. The image, in conjunction with the obtained infrastructure information, includes all information necessary to execute the diagnoses at the cell site by the diagnosis pod(s).

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for diagnosing remote sites of a distributed container orchestration system, comprising:
receiving, at a management cluster, a test suite custom resource defining an image to be used for a diagnosis of one or more components of a workload cluster deployed at the remote sites, wherein the image comprises at least one of:
a diagnosis module, or
a user-provided plugin to be used for the diagnosis;
identifying, at the management cluster, a failed component in the workload cluster;
obtaining, by the management cluster, infrastructure information about the workload cluster, wherein the infrastructure information identifies relationships between each of the one or more components of the workload cluster;
identifying, by the management cluster, the one or more components of the workload cluster for diagnosis based on the failed component, the infrastructure information about the workload cluster, and the test suite custom resource;
identifying, by the management cluster, at least one diagnosis site of the remote sites where the one or more components are running using the infrastructure information about the workload cluster; and
deploying a first pod at the at least one diagnosis site to execute the diagnosis of the one or more components.

2. The method of claim 1, further comprising:
providing, to the first pod at the at least one diagnosis site, the infrastructure information about the workload cluster;
executing, by the first pod, the diagnosis of the one or more components using at least one of the diagnosis module or the user-provided plugin and the infrastructure information about the workload cluster; and
returning test data from the first pod to the management cluster, the test data indicating results of performing the diagnosis.

3. The method of claim 2, wherein:
the image further comprises automatic repair functions; and
executing, by the first pod, the diagnosis of the one or more components using at least one of the diagnosis module or the user-provided plugin and the infrastructure information about the workload cluster comprises:
determining the diagnosis of at least one of the one or more components has failed; and
executing at least one of the automatic repair functions.

4. The method of claim 2, wherein:
the image further comprises suggestions; and
executing, by the first pod, the diagnosis of the one or more components using at least one of the diagnosis module or the user-provided plugin and the infrastructure information about the workload cluster comprises:
determining the diagnosis of at least one of the one or more components has failed; and
generating the test data with at least one of the suggestions.

5. The method of claim 1, wherein identifying, at the management cluster, the failed component in the workload cluster comprises receiving, at the management cluster, a configuration file identifying the failed component in the workload cluster.

6. The method of claim 1, wherein identifying, at the management cluster, the failed component in the workload cluster comprises detecting a failure of the failed component in the workload cluster.

7. The method of claim 1, wherein:
the image comprises the diagnosis module, and
the diagnosis module comprises:
a module configured to verify customizations made to the workload cluster;
a module configured to verify customizations made to worker nodes running in the workload cluster;
a module configured to verify customizations made to hosts running in the workload cluster; or
a module configured to verify customizations made to virtual machines (VMs) running in the workload cluster.

8. A system comprising:
one or more processors; and
at least one memory, the one or more processors and the at least one memory configured to:
receive, at a management cluster, a test suite custom resource defining an image to be used for a diagnosis of one or more components of a workload cluster deployed at remote sites of a distributed container orchestration system, wherein the image comprises at least one of:
a diagnosis module, or
a user-provided plugin to be used for the diagnosis;
identify, at the management cluster, a failed component in the workload cluster;
obtain, by the management cluster, infrastructure information about the workload cluster, wherein the infrastructure information identifies relationships between each of the one or more components of the workload cluster;
identify, by the management cluster, the one or more components of the workload cluster for diagnosis based on the failed component, the infrastructure information about the workload cluster, and the test suite custom resource;
identify, by the management cluster, at least one diagnosis site of the remote sites where the one or more components are running using the infrastructure information about the workload cluster; and
deploy a first pod at the at least one diagnosis site to execute the diagnosis of the one or more components.

9. The system of claim 8, wherein the one or more processors and the at least one memory are further configured to:
provide, to the first pod at the at least one diagnosis site, the infrastructure information about the workload cluster;
execute, by the first pod, the diagnosis of the one or more components using at least one of the diagnosis module or the user-provided plugin and the infrastructure information about the workload cluster; and
return test data from the first pod to the management cluster, the test data indicating results of performing the diagnosis.

10. The system of claim 9, wherein:
the image further comprises automatic repair functions; and
to execute, by the first pod, the diagnosis of the one or more components using at least one of the diagnosis module or the user-provided plugin and the infrastructure information about the workload cluster comprises to:
determine the diagnosis of at least one of the one or more components has failed; and
execute at least one of the automatic repair functions.

11. The system of claim 9, wherein:
the image further comprises suggestions; and
to execute, by the first pod, the diagnosis of the one or more components using at least one of the diagnosis module or the user-provided plugin and the infrastructure information about the workload cluster comprises to:
determine the diagnosis of at least one of the one or more components has failed; and
generate the test data with at least one of the suggestions.

12. The system of claim 8, wherein to identify, at the management cluster, the failed component in the workload cluster comprises to receive, at the management cluster, a configuration file identifying the failed component in the workload cluster.

13. The system of claim 8, wherein to identify, at the management cluster, the failed component in the workload cluster comprises to detect a failure of the failed component in the workload cluster.

14. The system of claim 8, wherein:
the image comprises the diagnosis module, and
the diagnosis module comprises:
a module configured to verify customizations made to the workload cluster;
a module configured to verify customizations made to worker nodes running in the workload cluster;
a module configured to verify customizations made to hosts running in the workload cluster; or
a module configured to verify customizations made to virtual machines (VMs) running in the workload cluster.

15. A non-transitory computer-readable medium comprising instructions that, when executed by one or more processors of a computing system, cause the computing system to perform operations for diagnosing remote sites of a distributed container orchestration system, the operations comprising:
receiving, at a management cluster, a test suite custom resource defining an image to be used for a diagnosis of one or more components of a workload cluster deployed at the remote sites, wherein the image comprises at least one of:
a diagnosis module, or
a user-provided plugin to be used for the diagnosis;
identifying, at the management cluster, a failed component in the workload cluster;
obtaining, by the management cluster, infrastructure information about the workload cluster, wherein the infrastructure information identifies relationships between each of the one or more components of the workload cluster;
identifying, by the management cluster, the one or more components of the workload cluster for diagnosis based on the failed component, the infrastructure information about the workload cluster, and the test suite custom resource;
identifying, by the management cluster, at least one diagnosis site of the remote sites where the one or more components are running using the infrastructure information about the workload cluster; and
deploying a first pod at the at least one diagnosis site to execute the diagnosis of the one or more components.

16. The non-transitory computer-readable medium of claim 15, wherein the operations further comprise:
providing, to the first pod at the at least one diagnosis site, the infrastructure information about the workload cluster;
executing, by the first pod, the diagnosis of the one or more components using at least one of the diagnosis module or the user-provided plugin and the infrastructure information about the workload cluster; and
returning test data from the first pod to the management cluster, the test data indicating results of performing the diagnosis.

17. The non-transitory computer-readable medium of claim 16, wherein:
the image further comprises automatic repair functions; and
executing, by the first pod, the diagnosis of the one or more components using at least one of the diagnosis module or the user-provided plugin and the infrastructure information about the workload cluster comprises:
determining the diagnosis of at least one of the one or more components has failed; and
executing at least one of the automatic repair functions.

18. The non-transitory computer-readable medium of claim 16, wherein:
the image further comprises suggestions; and
executing, by the first pod, the diagnosis of the one or more components using at least one of the diagnosis module or the user-provided plugin and the infrastructure information about the workload cluster comprises:
determining the diagnosis of at least one of the one or more components has failed; and
generating the test data with at least one of the suggestions.

19. The non-transitory computer-readable medium of claim 15, wherein identifying, at the management cluster, the failed component in the workload cluster comprises receiving, at the management cluster, a configuration file identifying the failed component in the workload cluster.

20. The non-transitory computer-readable medium of claim 15, wherein identifying, at the management cluster, the failed component in the workload cluster comprises detecting a failure of the failed component in the workload cluster.
